(19) United States
(12) Patent Application Publication
(10) Pub. No.: US 2018/0160483 A1
(43) Pub. Date: Jun. 7, 2018

(54) HEATING MODULE AND ELECTRIC HEATING DEVICE COMPRISING SUCH A HEATING MODULE

(71) Applicant: Valeo Systemes Thermiques, Le Mesnil Saint Denis (FR)

(72) Inventor: Serif Karaaslan, Le Mesnil Saint Denis Cedex (FR)

(73) Assignee: Valeo Systemes Thermiques, Le Mesnil Saint Denis (FR)

(21) Appl. No.: 15/575,416

(22) PCT Filed: May 23, 2016
(86) PCT No.: PCT/EP2016/061618

§ 371 Date: Nov. 20, 2017

(30) Foreign Application Priority Data
May 26, 2015 (FR) 1554719

(51) Int. Cl. H05B 3/24; B60H 1/22

(52) U.S. Cl. CPC H05B 3/24; H05B 2203/023; H05B 2203/02; B60H 1/2225

(57) ABSTRACT

Heating module (6) for an electric heating device, comprising at least two elements able to produce heat and at least three electrodes (52, 54, 56), each of these elements able to produce heat being disposed between two electrodes (52, 54, 56), characterized in that it comprises at least two linking means (32) each associated with a respective electrode (52, 4), which make it possible to link these electrodes (52, 54) to an electrical network, at least one of the electrodes (52) connected to a means of linking (32) being joined by a means of electrical connection (38) to an electrode (56) which is not joined to a means of electrical connection (38) in such a way to bring these two electrodes (52, 56) to the same electrical potential.

The invention falls within the field of motor vehicle ventilating, heating and/or air conditioning. It relates to heating electrical additional devices, comprising one or more heating modules, intended to be mounted in a ventilating, heating and/or air conditioning system of a motor vehicle.

More particularly, the invention relates to a heating additional device comprising heating elements with electrical resistors, for example positive temperature coefficient (PTC) resistors, which make it possible to quickly produce heat in the vehicles, particularly when the intention is to quickly heat the car interior.

Heating devices of this type comprise a heating body including heat exchange elements which can diffuse heat, which are associated with said heating elements. These heating additional devices also comprise connection means which allow the heating elements to be electrically joined to a source electric network on board the vehicle, for electrically powering the heating elements, and connection means which allow the heating additional device to be mechanically fixed to the ventilating, heating and/or air conditioning system.

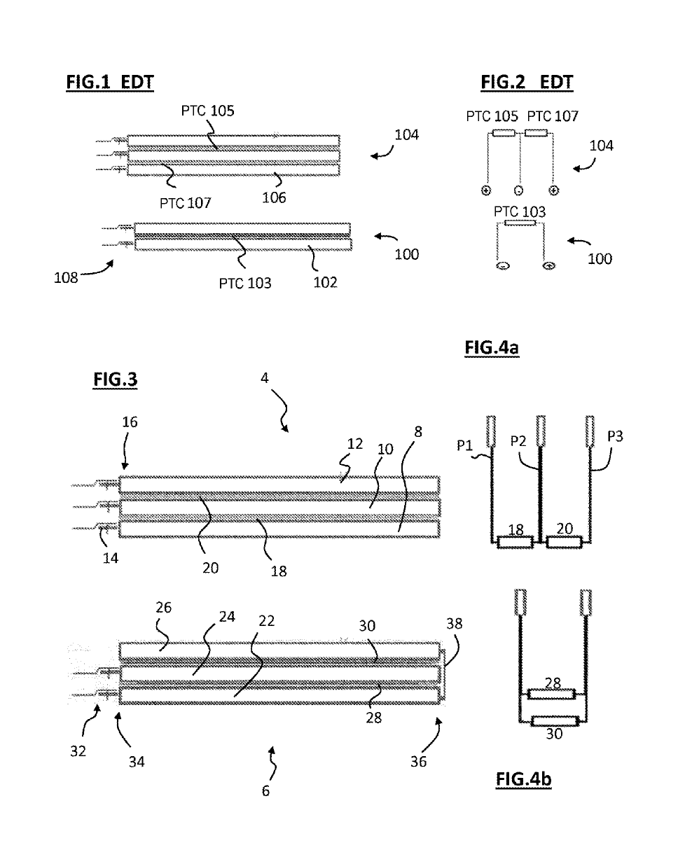

FIG. 1 illustrates an electric heating device suitable to be inserted according to the prior art into a ventilating, heating and/or air conditioning pipe in order to heat an air flow passing therethrough by heat dissipation. This heating device comprises two heating modules, namely a first heating module 100 which comprises an assembly of two elements suitable for exchanging heat 102 between which is arranged a resistive element PTC103 and a second heating module 104 which comprises an assembly of three elements suitable for exchanging heat 106 between which are arranged resistive elements PTC105 and PTC107. Each element suitable for exchanging heat 106 is extended at one of the ends thereof by a joining means such as a joining terminal 108 which allows for joining to an electric network of the vehicle for the electric powering of the heating device.

This type of heating device is joined to the electric network of the vehicle by means of a connector, not shown in this case, having five channels i.e. a connector in which five housings for receiving the joining means are provided, for joining according to the electric diagram illustrated in FIG. 2. It is noted that this type of five-channel connection is becoming widespread, particularly for joining heating devices without on-board electronics to an electric network or to a battery, and that this is particularly suitable for uses requiring a power of 1000 W or less. For example, in the illustrated example from the prior art, the first heating module can emit a power of 330 W while the second heating module can emit a power of 660 W, such that the heating additional device can emit a maximum power of approximately 1000 W.

The manufacturer of the heating additional device of this type is faced with the problem of conforming to the five-channel connector, which is standard, and is widely imposed by car manufacturers, which limited the power emitted for heating the air passing through the pipe in which the heating device is placed.

The aim of the present invention in particular is to propose, in this context of standardisation of the five-channel connectors, a heating device suitable for providing a greater heat, without necessarily modifying the size of the heat sinks used.

The present invention relates to a heating module for an electric heating device, comprising at least two elements suitable for producing heat and at least three electrodes, each of these elements suitable for producing heat being arranged between two electrodes, characterized in that it comprises at least two joining means each associated with a respective electrode, which make it possible to join these electrodes to an electric network, at least one of the electrodes joined to a joining means being linked by an electrical connection means to an electrode which is not linked to a joining means, such as to bring these two electrodes to the same electric potential.

Preferably, one electrode is arranged between two elements suitable for producing heat, each of these elements suitable for producing heat being arranged between the central electrode and an outer electrode.

The heating module according to the invention can further comprise one or more of the following characteristics, individually or in combination:
the electrical connection means and the joining terminals are arranged at opposite ends of the heating module, respectively;
the at least two electrodes joined to said at least two associated joining means are adjacent;
the at least two electrodes linked by said electrical connection means are not adjacent;
the heating module comprising two elements suitable for producing heat, three electrodes, and two joining means associated with an outer electrode and with a central electrode, respectively, so as to join these two electrodes to an electric network, the outer electrode being linked by an electrical connection means to the electrode which is not linked to a joining means, such as to bring these two electrodes to the same electric potential;
the heating module comprises at least three elements suitable for exchanging heat with the air flow passing through the heating module, these three elements each being associated with an electrode;
each electrode is arranged on at least one part of at least one side of the element suitable for exchanging heat, with which it is associated;
each electrode extends such as to define the sides of the element suitable for exchanging heat, with which it is associated.

The invention also relates to a heating device comprising at least one heating module as has just been presented.

The heating device according to the invention can further comprise one or more of the following characteristics, individually or in combination:
the heating device comprises a plurality of heating modules, from which at least one of these heating modules comprises one electrode more than it comprises joining means;
the heating device includes a first heating module which comprises three electrodes and three joining means each associated with an electrode, and a second heating module which comprises three electrodes and only two joining means;
the heating device comprises a frame suitable for receiving the heating modules, said frame comprising a back wall, said electrical connection means being rigidly connected to the back wall such that two electrodes are joined by means of this electrical connection means when the heating modules are arranged in the frame;
the electrical connection means takes the form of a metal blade;
the electrical connection means is partially embedded in the back wall of the frame.

It is particularly advantageous to provide a heating device in which a first heating module comprises three electrodes, three elements suitable for exchanging heat and three joining means, and a second heating module which comprises three electrodes, three elements suitable for exchanging heat, and only two joining means. Thus, it is possible to fit with the five-channel connector that is standard in the car industry, while increasing the number of provided elements suitable for exchanging heat and therefore the quantity of heat emitted by the heating device.

The heating device according to the invention can also further comprise one or more of the following characteristics, individually or in combination:
the at least one heating module extends, when it is arranged in the frame, in a general extension direction between a first end and a second end;
the general extension direction of said at least one heating module is substantially longitudinal;
said at least one element suitable for producing heat is a resistive element;
said at least one element suitable for producing heat is a resistive element of positive temperature coefficient (PTC) type;
said at least one element suitable for producing heat is a resistive element of positive temperature coefficient (PTC) type arranged in or on a support such as a bar;
said at least one associated element which is suitable for exchanging heat is a radiating element;
said at least one element suitable for producing heat is arranged between two elements suitable for exchanging heat;
each electrode extends such as to define the sides of the element suitable for exchanging heat with which it is associated, the assembly formed in this manner substantially having the shape of a parallelepiped.

The invention also relates to a ventilating, heating and/or air conditioning assembly, particularly comprising an electric heating device as has just been described, which is associated with a five-channel connector for joining to an electric network for the electric powering of the heating device.

Other characteristics and advantages of the present invention will emerge more clearly from the description and the drawings, wherein:

FIGS. 1 and 2 are schematic representations of the structure and of the electrical branching of heating modules according to the prior art, such as they have already been set out in presenting the invention;

FIGS. 3, 4a and 4b are representations similar to those of FIGS. 1 and 2, on this occasion representations of a heating device according to an embodiment of the invention, wherein a first heating module has a characteristic feature with respect to the prior art;

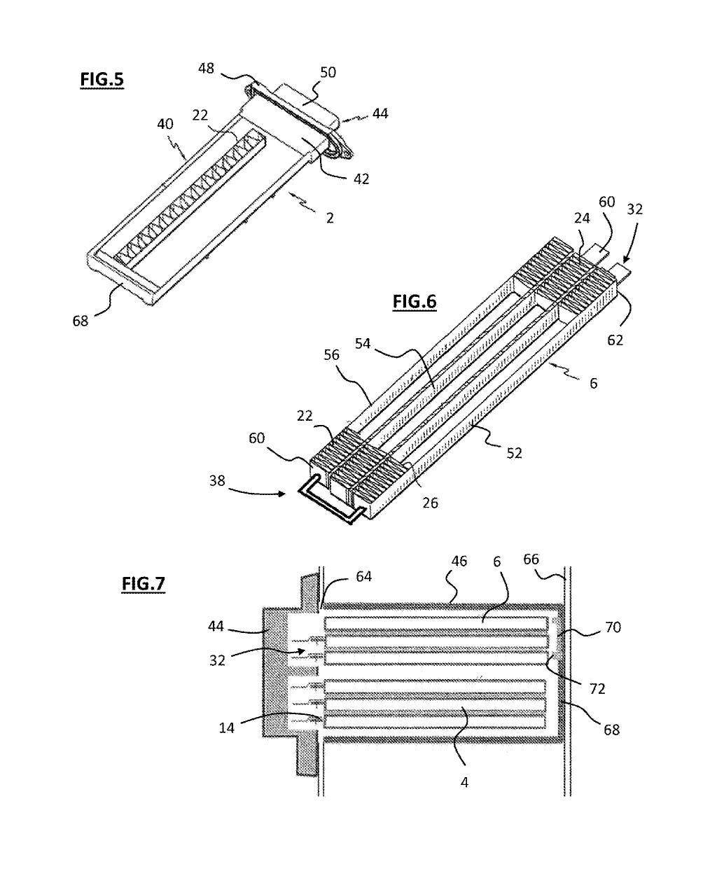

FIG. 5 is a perspective view of a heating device according to the invention, wherein a heating module, and a five-channel connector for joining the heating device to a source electric network, not shown in this case, are made partially visible;

FIG. 6 is a perspective view of a heating module according to an embodiment of the invention, comprising three elements suitable for exchanging heat and two joining means, the two outer elements suitable for exchanging heat being joined by an electrical connection means;

and FIG. 7 is a sectional side view, of a ventilating, heating, and/or air conditioning system according to the invention in which a cover houses heating modules for joining the latter to a five-channel connector and for arranging them through an air circulation pipe.

Reference is made to FIGS. 3-7 to successively describe an assembly of heating modules according to the invention and the specific electric joining thereof (FIGS. 3, 4a and 4b), an electric heating device according to the invention (FIGS. 5 and 6) and a ventilating, heating and/or air conditioning assembly comprising such a heating device (FIG. 7).

FIG. 3 illustrates an embodiment of the invention, specific with regard to the number of heating modules and the number of elements suitable for exchanging heat that each of these heating modules comprises. The heating device 2 in this embodiment comprises two heating modules 4, 6 suitable for extending into a canal through which an air flow to be heated passes.

A first heating module 4 comprises three elements suitable for exchanging heat 8, 10, 12 that are overlaid on each other, and electrodes associated with each of the elements suitable for exchanging heat 8, 10, 12. Each of these electrodes is extended by a tab 14 forming a proximal end 16 of the heating module, a joining means, each tab 14 being suitable to be connected to the electric network of the vehicle.

The electrodes and the elements suitable for exchanging heat which are associated therewith are at different electric potentials such that an electric current can flow through a positive temperature coefficient (PTC)-effect stone placed between two adjacent elements suitable for exchanging heat and forming a resistive element. It is understood that a PTC-effect stone can equally be a single stone extending over the entire length of the elements suitable for exchanging heat, or many stones spaced apart from one another and housed in the same plane. The first heating module 4 thus comprises two resistive elements 18 and 20.

A second heating module 6 also comprises three elements suitable for exchanging heat 22, 24 and 26 which are associated with three respective electrodes, and two resistive elements 28 and 30 and it differs from the first heating module 4 in that only two joining means 32 are arranged at the proximal end 34 of the heating module 6. At the opposite distal end 36, the second heating module 6 comprises an electrical connection means 38 suitable for keeping, at the same electric potential, the two outer elements suitable for exchanging heat 22 and 26, which are separated in the overlay of elements suitable for exchanging heat, by the central element suitable for exchanging heat 24. As can be seen in FIG. 3, one of the two outer elements 26 suitable for exchanging heat which does not comprise a joining means is linked by the electrical connection means 38 to the other outer element 22 suitable for exchanging heat. It is notable that, in this second heating module 6, there is one more element suitable for exchanging heat, and therefore one more electrode, than joining means.

FIGS. 4a and 4b illustrate the electric wiring diagram of the device according to the invention, with, more particularly, in FIG. 4a, the wiring diagram of the first heating module 4 and, in FIG. 4b, the wiring diagram of the second heating module 6.

The first heating module 4 is joined to a source electric network in the following manner: a first electrode corresponding to one of the outer elements suitable for exchanging heat is linked to a first potential P1 and a second electrode corresponding to the central element suitable for exchanging heat is linked to a second potential P2, such as to create an electric current flowing between the two electrodes and particularly passing through the corresponding resistive element 18 formed by the stones, such as to produce an emission of heat suitable for heating the air passing through the canal. The electric potential difference between the second electrode and a third electrode, corresponding to the other outer element suitable for exchanging heat and brought to a third potential P3, similarly makes it possible to create a current passing through the corresponding resistive element 20 formed by the stones.

The electric wiring diagram corresponding to the second heating module 6 differs from the electric wiring diagram of the first heating module 4 in that the resistive elements 28 and 30 are arranged in parallel, such as to require only two electric joining points. The two electrodes corresponding to the two outer elements suitable for exchanging heat are brought to the same electric potential, via a single connection to the source electric network, and via an electrical connection means 38 therebetween.

Upon examining these electric diagrams, it is understood that it will be possible to activate the resistive elements 18 and 20 of the first heating module 4 independently, whereas the resistive elements 28 and 30 of the second heating module 6 will always be activated at the same time. Thus, a heating device comprising two heating modules 4, 6 as described will be able to deliver, depending on the activation of a particular resistive element, a power corresponding to the power of one heating module (one of the resistive elements of the first heating module is activated), of two heating modules (either the two resistive elements of the first heating module, or the second heating module are/is activated), or of four heating modules (all are activated).

It is understood that, in the second heating module 6, the number of elements suitable for exchanging heat is greater than the number of joining means. In the illustrated example, each heating module comprises three elements suitable for exchanging heat, but it will be understood that the number of elements suitable for exchanging heat could be greater, given that, in at least one of the heating modules that a heating device according to the invention comprises, the number of joining means will be less than the number of elements suitable for exchanging heat, particularly in order to be able to fit specific connectors.

FIG. 5 illustrates an electric heating device 2 for heating an air flow. This type of electric radiator is used in motor vehicles to give a practically immediate boost of heat. It is normally placed crosswise in the main air stream of the system such as to convert the electric energy drawn from the vehicle into thermal energy released into the air passing through the air conditioning system. In the illustrated example, the heating device does not include a control electronic module, and it is possible to locate the control management for this electric radiator elsewhere on the vehicle.

This device is made up of a heating body 40 and of a joining interface 42 suitable to be linked to a connector 44, in this case a five-channel connector, in order to electrically link the heating device to the power supply on the vehicle.

The heating body 40 is made up of a frame 46 made from plastic, for example polypropylene or polyamid, inside which heating modules 4, 6 are integrated, only one being made visible in FIG. 5.

The connector 44 particularly comprises an abutting edge 48 and a sleeve 50 for connecting to the electrical power supply coming from the vehicle. The abutting edge 48 makes it possible to firmly hold the electric radiator in position in the ventilating, heating and/or air conditioning system.

FIG. 6 shows a heating module 6 according to an embodiment of the invention. This heating module 6 comprises three conductive electrodes 52, 54 and 56 which extend longitudinally. Each of these electrodes 52, 54, 56 is generally shaped as a “C” in the longitudinal plane thereof with the two longitudinal ends 58 and 60 of these electrodes folded transversely. The end referenced 58 is extended longitudinally in order to form a tab 62 which is part of a joining terminal 32 as described above with respect to FIG. 3.

The “C” shape of the electrodes 52, 54, 56 makes it possible to enclose a metal strip folded on itself at a regular interval such as to form an element suitable for exchanging heat 22, 24, 26. For the sake of clarity, the elements suitable for exchanging heat 22, 24, 26 are only shown partially, the part not shown being identical to the representation visible in the figure. The electrodes 52, 54, 56 clasp the elements suitable for exchanging heat 22, 24, 26 such that the latter bear against PTC (positive temperature coefficient)-effect stones 28 and 30. In the example shown in this figure, it is noted that the heating module 6 comprises two assemblies of six PTC-effect stones 28 spaced apart from one another by a slight interval. The PTC-effect stones are held in an adhered manner on the elements suitable for exchanging heat by means of a thermal adhesive that is, however, sufficiently strong to confer an electric contact between the element suitable for exchanging heat and the PTC-effect stone. It must be noted that the electrodes and the elements suitable for exchanging heat that are dedicated thereto are at different electric potentials such as to electrically power the PTC-effect stone 28.

According to the invention, and as can be particularly seen in FIG. 6, it is possible to observe that one electrode 56 is not extended by a tab, unlike the other two electrodes 52, 54. This electrode 56 that is not extended by a tab corresponds to one of the outer elements suitable for exchanging heat 22, i.e. one of the elements suitable for exchanging heat surrounding the central element suitable for exchanging heat 24. This electrode 56 is connected to the electrode 52 corresponding to the other outer element suitable for exchanging heat 26 by a metal piece, forming an electrical connection means 38 for joining these two electrodes 52, 54 to the same electric potential. The electrical connection means 38 is arranged at the proximal end 36 of the heating module 6, having a curve suitable for allowing the two outer elements suitable for exchanging heat 22, 26 to be joined without contact with the element suitable for exchanging heat 24.

Based on the illustration in FIG. 7, a description will now be given of an embodiment of the invention in a preferred use, with a frame 46 housing the heating modules 4, 6, which frame is inserted into an opening 64 formed in the wall 66 of a canal of a ventilating, heating and/or air conditioning system.

The frame 46 is produced from a specific material, that is light, but sufficiently resistant, for example a plastic, of polypropylene or polyamid type. The frame 46 comprises a back wall 68, with the distal ends 36 of the modules 4, 6 being arranged to face it, and it comprises transverse walls that are apertured such that the heating device can be crossed by the air present in the pipe in which the cover is inserted.

A metal blade 70 is attached to the back wall 68, in order to form the electrical connection means 38 allowing the two elements suitable for exchanging heat and 26, which are arranged on either side of the central element suitable for exchanging heat 24 of the stack, to be electrically joined. It is advantageous that the blade 70 is partially embedded in the thickness of the back wall 68, and that only the two ends of the blade 70 project beyond this wall 68 in order to form electric contact studs 72 facing only the elements suitable for exchanging heat 22, 26 to be placed at the same potential.

It is understood that the frame 46 firstly allows the heating modules to be held with respect to one another and therefore the joining means to be correctly positioned with respect to the connector to the electric network, and secondly the blade forming the electrical connection means of two elements suitable for exchanging heat to be fixed therebetween. However, it would be possible to do without the frame, at least for the back wall bearing the plate, and to rigidly connect this blade directly to the canal in which the heating modules are housed, or indeed to weld the blade on the electrodes associated with the elements suitable for exchanging heat that are to be joined.

The above description clearly explains how the invention makes it possible to achieve the objectives determined thereby and, in particular, to propose a heating electrical additional device, which makes it possible, for a given associated connector type, to deliver a heating power which is greater than that delivered by the heating devices of the prior art.

1. A heating module for an electric heating device, comprising:
at least two elements for producing heat;
at least three electrodes
wherein each of the at least two elements for producing heat is arranged between two electrodes of the three electrodes; and
at least two joining means each associated with a respective electrode, for joining these electrodes to an electric network, at least one of the electrodes joined to a joining means being linked by an electrical connection means to an electrode which is not linked to a joining means, such as to bring these two electrodes to the same electric potential.

2. The heating module according to claim 2, wherein the electrical connection means and the joining terminals are arranged at opposite ends of the heating module, respectively.

3. The heating module according to claim 1, wherein the at least two electrodes joined to said at least two associated joining means are adjacent.

4. The heating module according to claim 1, wherein the at least two electrodes linked by said electrical connection means are not adjacent.

5. The heating module according to claim 1, further comprising two elements for producing heat, three electrodes, and two joining means associated with an outer electrode and with a central electrode, respectively, so as to join these two electrodes to an electric network, the outer electrode being linked by an electrical connection means to the electrode which is not linked to a joining means, such as to bring these two electrodes to the same electric potential.

6. The heating module according to claim 1, further comprising at least three elements for exchanging heat with the air flow passing through the heating module, these three elements each being associated with an electrode.

7. The heating module according to claim 6, wherein each electrode is arranged on at least one part of at least one side of the element for exchanging heat, with which the electrode is associated.

8. The heating module according to claim 7, wherein each electrode extends such as to define the at least one sides of the element suitable for exchanging heat, with which the electrode is associated.

9. A heating device comprising at least one heating module according to claim 1.

10. The heating device according to claim 9, further comprising a plurality of heating modules, wherein at least one of the plurality of heating modules comprises one electrode more than it joining means.

11. The heating device according to claim 10, further comprising a first heating module which comprises three electrodes and three joining means each associated with an electrode, and a second heating module which comprises three electrodes and only two joining means.

12. The heating device according to claim 9, further comprising a frame suitable for receiving the heating modules, said frame comprising a back wall, said electrical connection means being rigidly connected to the back wall such that two electrodes are joined by means of this electrical connection means when the heating modules are arranged in the frame.

13. The heating device according to claim 12, wherein the electrical connection means takes the form of a metal blade.

14. The heating device according to claim 12, wherein the electrical connection means is partially embedded in the back wall of the frame.

15. A ventilating, heating and/or air conditioning assembly, comprising a heating device according to claim 9, which is associated with a five-channel connector for joining to an electric network for the electric powering of the heating device.
